(19) United States
(12) Patent Application Publication
(10) Pub. No.: US 2012/0311511 A1
(43) Pub. Date: Dec. 6, 2012

(54) MASK INSPECTION METHOD, MASK PRODUCTION METHOD, SEMICONDUCTOR DEVICE PRODUCTION METHOD, AND MASK INSPECTION DEVICE

(76) Inventors: Takafumi TAGUCHI, Kanagawa (JP); Toshiya Kotani, Tokyo (JP); Chikaaki Kodama, Kanagawa (JP); Fumiharu Nakajima, Kanagawa (JP)

(21) Appl. No.: 13/399,042

(22) Filed: Feb. 17, 2012

(30) Foreign Application Priority Data
May 31, 2011 (JP) 2011-122567

(51) Int. Cl. G06F 17/50

(52) U.S. Cl. 716/52; 716/55

(57) ABSTRACT

A mask inspection method according to the embodiments, original data corresponding to a semiconductor integrated circuit pattern to be formed on a substrate is created. After that, original production simulation which mocks an original production process is performed on the original data to derive information relating to an original pattern shape in the case of forming an original pattern corresponding to the original data on an original. After that, whether or not the information relating to an original pattern shape satisfies a predetermined value decided based on the original production process is determined.

### CROSS-REFERENCE TO RELATED APPLICATIONS

This application is based upon and claims the benefit of priority from Japanese Patent Application No. 2011-122567, filed on May 31, 2011; the entire contents of which are incorporated herein by reference.

### FIELD

Embodiments described herein relate generally to a mask inspection method, a mask production method, a semiconductor device production method, and a mask inspection device.

### BACKGROUND

Along with recent miniaturization of semiconductor devices, a mask shape after OPC (Optical Proximity Correction) has become more complicated. Therefore, in the conventional rule-based mask data check, it has become difficult to perform the mask data check without making noise (pseudo error on mask data) in mask inspection.

For example, some of mask data are determined to be acceptable in mask inspection (inspection on actual pattern) but are determined to be rejectable (embargo) in mask data check since the rule of the mask data check does not correspond to pattern variation. In such case, there is no other choice but to perform correction (unnecessary OPC) which is not optimized for the mask data, and, as a result, a problem of a reduction in common margin of lithography occurs. Also, a load in MDP (Mask Data Preparation) is increased when it is necessary to correct the conditions of OPC for every rejection. Therefore, it is desired to perform the mask inspection on the mask data with high accuracy and easily.

### BRIEF DESCRIPTION OF THE DRAWINGS

FIG. 1 is a block diagram illustrating a configuration of a mask inspection system according to the embodiments;

FIG. 2 is a flowchart illustrating a processing flow in mask inspection processing according to the embodiments;

FIGS. 3A to 3C are diagrams illustrating simulation results;

FIG. 4 is a diagram illustrating examples of positions of mask data for which hotspot determination is performed;

FIGS. 5A and 5B are diagrams each illustrating a lithography margin; and

FIG. 6 is a diagram illustrating a hardware configuration of a mask lithography simulation device.

### DETAILED DESCRIPTION

According to one embodiment, an imprint method is provided. Resist as transfer material is dropped to a substrate to be transferred where a template pattern formed on a template is transferred in the imprint method.

According to an embodiment, a mask inspection method is provided. In the mask inspection method, original data corresponding to a semiconductor integrated circuit pattern to be formed on a substrate is created. After that, original production simulation which mocks original production process is performed on the original data to derive, as original production pattern information, information relating to an original pattern shape in the case where an original pattern corresponding to the original data is formed on an original. After that, it is determined whether or not the original production pattern information satisfies a predetermined value which is decided based on the original production process. Also, original inspection simulation which mocks an optical system of an original inspection device to be used for inspection of the original is performed to derive, as original measurement pattern information, information relating to an original pattern shape to be detected when the original inspection device inspects the original. After that, it is determined whether or not a result of the original inspection is within an allowable range by using the original measurement pattern information.

Exemplary embodiments of a mask inspection method, a mask production method, a semiconductor device production method, and a mask inspection device will be explained below in detail with reference to the accompanying drawings. The present invention is not limited to the following embodiments. In the following description, among mask patterns, a pattern on data is referred to as mask data, and an actual pattern formed on a mask is referred to as a mask pattern.

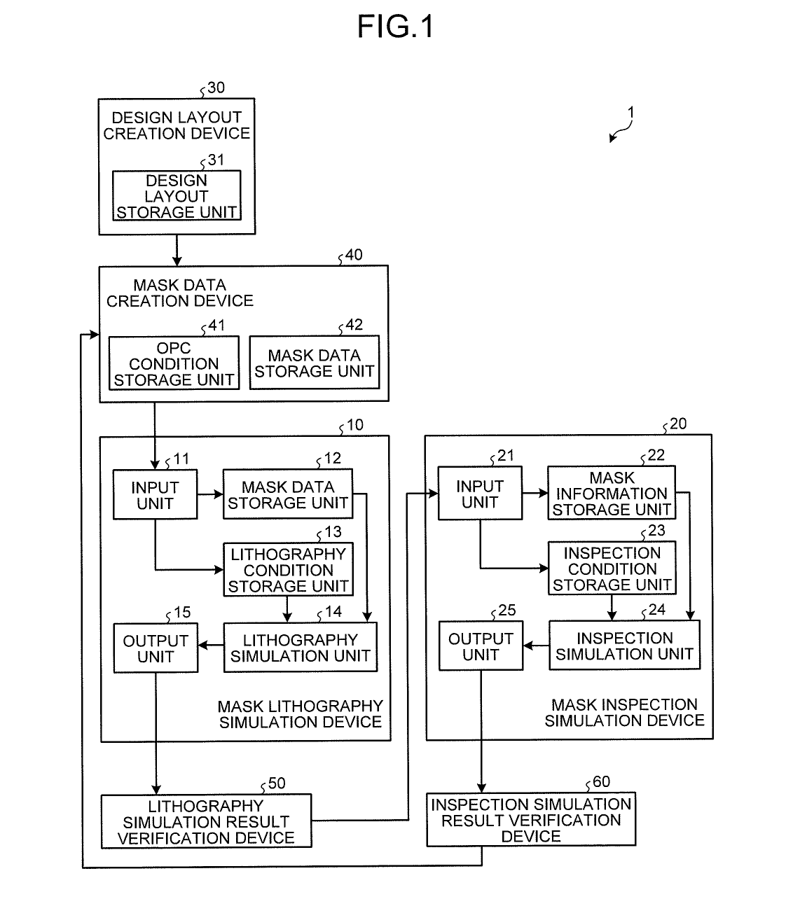

FIG. 1 is a block diagram illustrating a configuration of a mask inspection system according to the embodiments. A mask inspection system 1 is a system which performs inspection of mask data. The mask inspection system 1 has a design layout creation device 30, a mask data creation device 40, a mask lithography (drawing) simulation device 10, a mask inspection simulation device 20, a lithography simulation result verification device 50, and an inspection simulation result verification device 60.

The design layout creation device 30 is a computer or the like which creates design layout data of a semiconductor device (semiconductor integrated circuit pattern) to be formed on a substrate (wafer). The design layout creation device 30 is provided with a design layout storage unit 31. The design layout storage unit 31 is a memory or the like which stores the created design layout data. The design layout creation device 30 sends the design layout data to the mask data creation device 40.

The mask data creation device 40 is a computer or the like which creates mask data corresponding to the design layout data by executing OPC (Optical Proximity Correction) on the design layout data created by the design layout creation device 30. The mask data creation device 40 is provided with an OPC condition storage unit 41 and a mask data storage unit 42. The OPC condition storage unit 41 is a memory or the like which stores OPC conditions (OPC conditions C1 described later in this specification) for performing OPC. The mask data storage unit 42 is a memory or the like which stores created mask data. The mask data creation device 40 creates mask data from the design layout data by using the OPC conditions C1. The mask data creation device 40 sends the created mask data to the mask lithography simulation device 10.

The mask lithography simulation device (mask inspection device) 10 is a computer or the like which performs simulation (mask lithography simulation) based on the mask data on a mask pattern to be formed on a mask (original). The mask lithography simulation device 10 performs the mask lithography simulation by mocking a process for producing the mask.

The mask lithography simulation device 10 is provided with an input unit 11, a mask data storage unit 12, a lithography condition storage unit 13, a lithography simulation unit 14, and an output unit 15. The input unit 11 inputs the mask data created by the mask data creation device 40 and sends the mask data to the mask data storage unit 12. Also, the input unit 11 inputs lithography conditions (lithography conditions C2 described later in this specification) and contents of change in the lithography conditions C2 inputted by a designer and sends the lithography conditions C2 and the contents of change to the lithography condition storage unit 13.

Each of the mask data storage unit 12 and the lithography condition storage unit 13 is a memory or the like which stores the mask data or the lithography conditions. In the case where new mask data are sent to the mask data storage unit 12, the mask data storage unit 12 replaces the current mask data with the new mask data (overwriting). In the case where new lithography conditions C2 are sent to the lithography condition storage unit 13, the lithography condition storage unit 13 replaces the current lithography conditions C2 with the new lithography conditions C2 (overwriting).

The replacement with the new mask data may be replacement of part or whole of the mask data. Also, the replacement with the new lithography conditions C2 may be replacement of part or whole of the lithography conditions C2. Also, the mask lithography simulation device 10 may keep the old mask data within the mask data storage unit 12. Further, the mask lithography simulation device 10 may keep the old lithography conditions C2 within the lithography condition storage unit 13.

The lithography simulation unit 14 performs mask lithography simulation by using the lithography conditions C2 in the lithography condition storage unit 13 and the mask data (original data) in the mask data storage unit 12. The mask lithography simulation is simulation (original production simulation which mocks original production process) for deriving a mask pattern (original production pattern information) (information relating to an original pattern shape) in the case where a mask pattern corresponding to the mask data is formed on a mask.

The lithography simulation unit 14 sends the derived mask pattern (mask lithography simulation result) to the output unit 15. The output unit 15 sends the mask lithography simulation result to the lithography simulation result verification device 50.

The lithography simulation result verification device (verification unit) 50 is a computer or the like which inspects whether or not there is a hotspot in the mask pattern based on the mask lithography simulation result. The hotspot is a portion on which a probability of mask pattern defect is higher than a predetermined value. In other words, the hotspot is a portion on which a possibility of resulting in pattern formation defect (disconnection, short-circuiting, or the like of pattern) is higher than a predetermined value when pattern formation is performed on a wafer. A determination standard for determining the hotspot is decided based on a mask production process. In the case where the mask pattern does not satisfy the predetermined value which is the determination standard, the mask pattern is the hotspot. The hotspot at this stage is the hotspot which is detected based on the mask lithography simulation, and this hotspot is referred to as “mask lithography hotspot” in the following description.

Upon detection of the mask lithography hotspot in verification of the lithography simulation result, the lithography simulation result verification device 50 outputs a position of the mask lithography hotspot to an external device (display device or the like). When the mask lithography hotspot is not detected in the verification of the lithography simulation result, the lithography simulation result verification device 50 sends the lithography simulation result to the mask inspection simulation device 20 as mask information.

The mask inspection simulation device (mask inspection device) 20 is a computer or the like which performs simulation (mask inspection simulation) based on the lithography simulation result on a mask pattern to be observed by a mask inspection device (device which performs mask pattern inspection).

The mask inspection simulation device 20 is provided with an input unit 21, a mask information storage unit 22, an inspection condition storage unit 23, an inspection simulation unit 24, and an output unit 25. The input unit 21 inputs the mask information (lithography simulation result) which is sent from the lithography simulation result verification device 50 and sends the mask information to the mask information storage unit 22. Also, the input unit 21 inputs inspection conditions (inspection conditions C3 described later in this specification) and contents of change in the inspection conditions C3 inputted by the designer and sends the inspection conditions C3 and the contents of change to the inspection condition storage unit 23.

Each of the mask information storage unit 22 and the inspection condition storage unit 23 is a memory or the like, and the mask information storage unit 22 and the inspection condition storage unit 23 store the mask pattern and the inspection conditions C3, respectively. In the case where new mask information is sent to the mask information storage unit 22, the mask information storage unit 22 replaces the current mask information with the new mask information (overwriting). In the case where new inspection conditions C3 are sent to the inspection condition storage unit 23, the inspection condition storage unit 23 replaces the current inspection conditions C3 with the new inspection conditions C3 (overwriting).

The replacement with the new mask information may be replacement of part or whole of the mask information. Also, the replacement with the new inspection conditions C3 may be replacement of part or whole of the inspection conditions C3. Also, the mask inspection simulation device 20 may keep the old mask information within the mask information storage unit 22. Further, the mask inspection simulation device 20 may keep the old inspection conditions C3 within the inspection condition storage unit 23.

The inspection simulation unit 24 performs mask inspection simulation by using the inspection conditions C3 in the inspection condition storage unit 23 and the mask pattern in the mask information storage unit 22. The mask inspection simulation is simulation (original inspection simulation which mocks an optical system of an original inspection device) for deriving a mask pattern (original measurement pattern information) (information relating to an original pattern shape) which is observed by the mask inspection device when the lithography simulation result (mask pattern) is formed on a mask. The inspection simulation unit 24 sends the mask pattern which is the derived inspection object to the output unit 15. The output unit 15 sends the mask inspection simulation result to the inspection simulation result verification device 60. The inspection simulation result verification device 60 is (determination unit) a computer or the like which inspects whether or not there is a hotspot in the mask pattern based on the mask inspection simulation result. The hotspot at this stage is the one which is determined to be a hotspot by the mask inspection device and is referred to as “mask inspection hotspot” in the following description.

Upon detection of the mask inspection hotspot in verification of the inspection simulation result, the inspection simulation result verification device 60 outputs a position of the mask inspection hotspot to an external device (display device or the like). When the mask inspection hotspot is not detected in the verification of the inspection simulation result, the inspection simulation result verification device 60 informs the mask data creation device 40 that the mask inspection hotspot is not detected.

When the position of the mask lithography hotspot and the position of the mask inspection hotspot extracted by the lithography simulation result verification device 50 and the inspection simulation result verification device 60 are displayed on the display device or the like, at least one of the mask production process conditions (OPC conditions C1, lithography conditions C2, or the like), the inspection conditions C3, and the design layout data is changed by the designer. For example mask production process conditions (processing conditions of the original production process) include at least one of conditions relating to mask lithography (original lithography) and conditions relating to mask (original) processing process when forming the mask pattern corresponding to the mask data on the mask.

Also, when the mask data creation device 40 is informed from the inspection simulation result verification device 60 that the mask inspection hotspot is not detected, the latest mask data stored in the mask data storage unit 42 are used for the mask production.

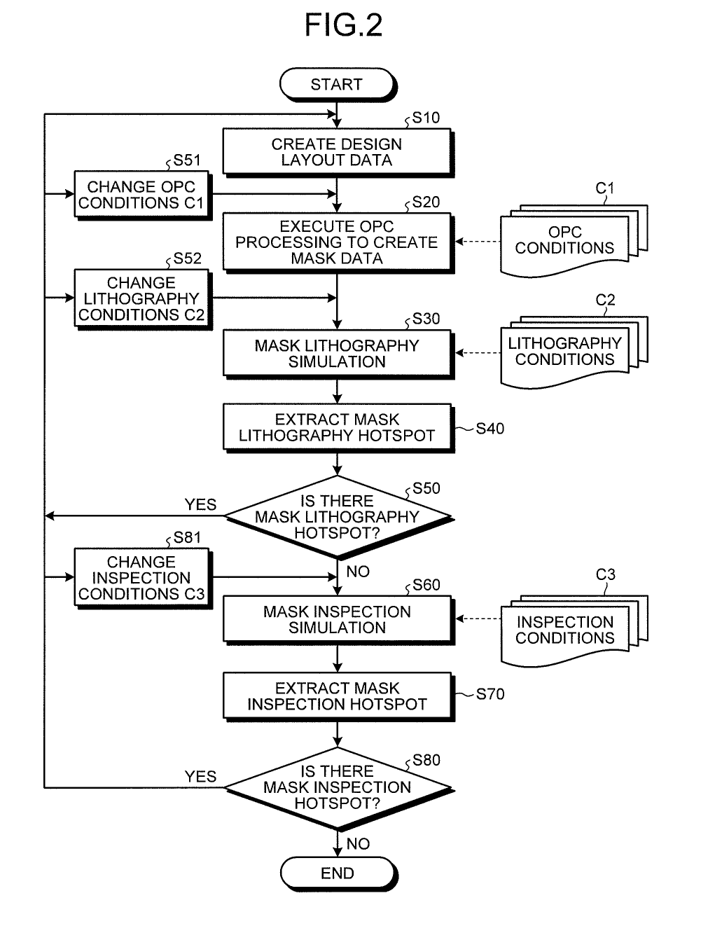

Hereinafter, a processing flow of mask inspection processing according to the embodiments will be described. FIG. 2 is a flowchart illustrating the processing flow in the mask inspection processing according to the embodiments. In the present embodiments, the mask inspection system 1 performs the mask lithography simulation on mask data after OPC in the mask inspection processing, and, after that, the mask lithography hotspot detection is performed. Further, the mask inspection system 1 performs the mask inspection simulation to detect the mask inspection hotspot. In the case where the mask lithography hotspot or the mask inspection hotspot is detected, the mask inspection system 1 corrects the error.

Hereinafter, the processing flow of the mask inspection processing will be described in detail according to the flowchart of FIG. 2. The design layout creation device 30 creates design layout data of a semiconductor device to be formed on a wafer (Step S10) and causes the design layout storage unit 31 to store the design layout data. The design layout creation device 30 sends the design layout data to the mask data creation device 40.

The mask data creation device 40 creates mask data which correspond to the design layout data by executing OPC on the design layout data created by the design layout creation device 30 (Step S20) and causes the mask data storage unit 42 to store the mask data. In other words, original data corresponding to a semiconductor integrated circuit pattern to be formed on a substrate is created.

Here, the mask data creation device 40 creates the mask data from the design layout data by using the OPC conditions C1 in the OPC condition storage unit 41. The mask data creation device 40 sends the mask data to the mask lithography simulation device 10.

The input unit 11 of the mask lithography simulation device 10 inputs the mask data created by the mask data creation device 40 and causes the mask data storage unit 12 to store the mask data. The lithography simulation unit 14 performs mask lithography simulation by using the lithography condition C2 in the lithography condition storage unit 13 and the mask data in the mask data storage unit 12 (Step S30). In other words, original production simulation which mocks original production process is performed on the original data to derive, as original production pattern information, information relating to an original pattern shape in the case where an original pattern corresponding to the original data is formed on an original. The lithography simulation unit 14 sends a derived mask lithography simulation result (mask pattern) to the output unit 15. The output unit 15 sends the mask lithography simulation result to the lithography simulation result verification device 50.

The lithography simulation result verification device 50 extracts a mask lithography hotspot from the mask pattern based on the mask lithography simulation result (Step S40). For example, the lithography simulation result verification device 50 extracts the mask lithography hotspot based on whether or not the mask lithography simulation result satisfies the predetermined value (specs) which is decided based on the mask production process. In other words, it is determined whether or not the original production pattern information satisfies a predetermined value which is decided based on the original production process.

In the case where there is the mask lithography hotspot (Yes in Step S50), the lithography simulation result verification device 50 causes the display device or the like to display the position of the mask lithography hotspot. Accordingly, at least one of the lithography conditions C2, the OPC conditions C1, and the design layout data is changed by the designer.

### (Change of Design Layout Data)

In the case of changing the design layout data, the processing of Steps S10 to S50 is repeated. More specifically, the mask data creation device 40 creates design layout data again (Step S10) and sends the re-created design layout data to the mask data creation device 40. After that, the mask data creation device 40 creates mask data which correspond to the design layout data again by executing OPC on the re-created design layout data (Step S20) and causes the mask data storage unit 42 to store the re-created mask data. Further, the mask lithography simulation device 10 overwrites the re-created mask data on the mask data storage unit 12. The mask lithography simulation device 10 uses the new mask data in the mask data storage unit 12 to perform the mask lithography simulation (Step S30). Further, the lithography simulation result verification device 50 extracts a mask lithography hotspot from the mask pattern based on a mask lithography simulation result (Step S40).

### (Change of OPC Conditions C1)

In the case of changing the OPC conditions C1, the designer changes the OPC conditions C1 (Step S51). The OPC conditions C1 after the change are overwritten in the OPC condition storage unit 41, and then the processing of Steps S20 to S50 is repeated. More specifically, the mask data creation device 40 executes OPC under the latest OPC conditions C1 in the OPC condition storage unit 41 on the latest design layout data to create mask data which correspond to the design layout data again (Step S20) and causes the mask data storage unit 42 to store the re-created mask data. After that, the processing of Steps S30 to S50 is performed.

### (Change of Lithography Conditions C2)

In the case of changing the lithography conditions C2, the designer changes the lithography conditions C2 (Step S52). The lithography conditions C2 after the change are overwritten in the lithography condition storage unit 13, and then the processing of Steps S30 to S50 is repeated. More specifically, the mask lithography simulation device 10 performs mask lithography simulation by using the latest mask data in the mask data storage unit 12 and the latest lithography conditions C2 in the lithography condition storage unit 13. After that, the processing of Steps S40 and S50 is performed.

In the mask inspection system 1, any one of the processing of S10 to S50, Step S51, the processing of S20 to S50, Step S52, and the processing of S30 to S50 is repeated until no mask lithography hotspot is extracted by the lithography simulation result verification device 50.

When there is no mask lithography hotspot (No in Step S50), the lithography simulation result verification device 50 sends the lithography simulation result to the mask inspection simulation device 20 as the mask information. The mask lithography simulation result when there is no mask lithography hotspot is the limit of the mask lithography (mask production).

The input unit 21 of the mask inspection simulation device 20 inputs the mask information (lithography simulation result) sent from the mask inspection simulation device 20 and causes the mask information to be stored in the mask information storage unit 22.

The inspection simulation unit 24 performs mask inspection simulation by using the inspection conditions C3 in the inspection condition storage unit 23 and the mask pattern in the mask information storage unit 22 (Step S60). In other words, original inspection simulation which mocks an optical system of an original inspection device to be used for inspection of the original is performed to derive, as original measurement pattern information, information relating to an original pattern shape to be detected when the original inspection device inspects the original. The inspection simulation unit 24 sends a derived mask pattern (mask inspection simulation result) to the output unit 15. The output unit 15 sends the mask inspection simulation result to the inspection simulation result verification device 60.

The inspection simulation result verification device 60 extracts a mask inspection hotspot from the mask pattern based on the mask inspection simulation result (Step S70). In other words, it is determined whether or not a result of the original inspection is within an allowable range by using the original measurement pattern information. In the case where there is the mask inspection hotspot, (yes in Step S80), the inspection simulation result verification device 60 causes the display device or the like to display a position of the mask inspection hotspot. Accordingly, at least one of the inspection conditions C3, the lithography conditions C2, and the OPC conditions C1, and the design layout data is changed by the designer (Step S51, S52, or S81). The lithography conditions C2, the OPC conditions C1, and the design layout data are changed in the same manner as in the above-described lithography condition changing processing, OPC conditions C1 changing processing, and design layout data changing processing.

### (Change of Inspection Conditions C3)

In the case of changing the inspection conditions C3, the designer changes the inspection conditions C3 (Step S81). The inspection conditions C3 after the change are overwritten in the inspection condition storage unit 23, and then the processing of Steps S60 to S80 is repeated. More specifically, the mask inspection simulation device 20 performs mask inspection simulation by using the latest inspection conditions C3 in the inspection condition storage unit 23 and the latest mask pattern in the mask information storage unit 22 (Step S60). The inspection simulation result verification device 60 extract a mask inspection hotspot from the mask pattern based on a mask inspection simulation result (Step S70).

The inspection simulation result verification device 60 compares the mask inspection simulation result and a reference image, for example, to extract as the mask inspection hotspot a pattern of which a dimensional difference between the mask inspection simulation result and the reference image is outside an allowable range. The reference image is a pattern which is obtainable by adding the predetermined allowable range (dimensional allowance) to the mask data. Also, the inspection simulation result verification device 60 may extract the mask inspection hotspot based on whether or not the mask inspection simulation result satisfies the predetermined value (specs) decided based on the mask production process.

The inspection simulation result verification device 60 may extract the mask inspection hotspot based on a comparison result by setting the mask inspection simulation result as the reference image and comparing the mask inspection simulation result with a mask pattern in the case of actually observing the mask pattern by using the mask inspection device.

In the mask inspection system 1, any one of the processing of S10 to S80, Step S51, the processing of S20 to S80, Step S52, the processing of S30 to S80, Step S81, and the processing of S60 to S80 is repeated until no mask inspection hotspot is extracted by the inspection simulation result verification device 60.

When there is no mask inspection hotspot (No in Step S80), the inspection simulation result verification device 60 informs the mask data creation device 40 that any mask inspection hotspot is not detected. Accordingly, the latest mask data stored in the mask data storage unit 42 in the mask data creation device 40 are used for the mask production. The mask inspection simulation result when there is no mask inspection hotspot is the limit of the mask inspection (detection of abnormal pattern).

The inspection simulation unit 24 may use the mask data in place of the mask lithography simulation result for performing the mask inspection simulation. In this case, the mask information is the mask data, and the mask data as the mask information are sent from the mask lithography simulation device 10 to the mask inspection simulation device 20.

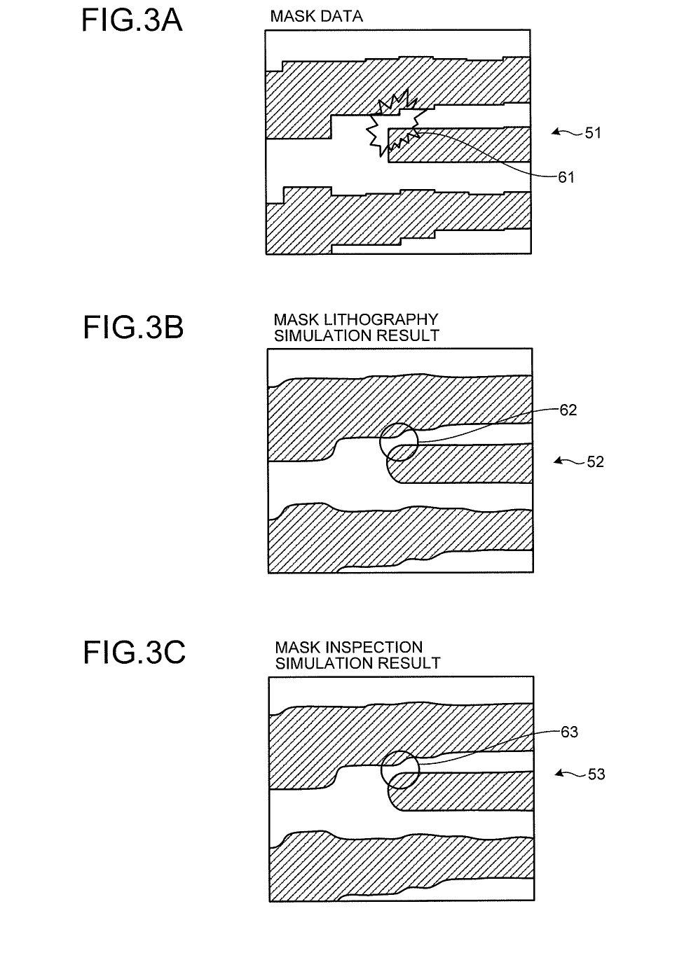

FIGS. 3A to 3C are diagrams illustrating simulation results. FIG. 3A is a top view illustrating one example of mask data 51. FIG. 3B is a top view illustrating one example of mask lithography simulation result 52 derived by using the mask data 51 illustrated in FIG. 3A. FIG. 3C is a top view illustrating one example of mask inspection simulation result 53 derived by using the mask lithography simulation result 52 illustrated in FIG. 3B.

Some of mask patterns are determined to be acceptable in mask inspection (inspection on actual pattern) but are determined to be rejectable in mask data check using mask data (rule-based minimum dimension check on the mask data). For example, when the mask data check is performed by using the mask data 51 illustrated in FIG. 3A, a portion (defective region 61) which is determined to be rejectable occurs though acceptance is given to the actual pattern since the mask data check is inaccurate.

The mask lithography simulation result 52 is a mask pattern (expected pattern) in the case where a mask pattern corresponding to the mask data 51 is formed on a mask and is derived by mocking a process for producing the mask. Therefore, the mask pattern of the mask lithography simulation result 52 is closer to the actual mask pattern shape than the mask pattern of the mask data 51. Since the mask inspection simulation device 20 detects the mask lithography hotpot from the mask lithography simulation result 52 in the present embodiments, it is possible to inspect the presence/absence of the mask lithography hotspot with high accuracy.

Therefore, even in the case where the defective region 61 is detected by the inspection using the mask data, the defective region 61 can sometimes be an acceptable region 62 by the inspection using the mask lithography simulation result 52. A position of the acceptable region 62 on the mask lithography simulation result 52 corresponds to the position of the defective region 61 on the mask data.

The mask inspection simulation result 53 is a mask pattern (expected pattern) in the case of observing a mask pattern corresponding to the mask lithography simulation result 52 by using the mask inspection device and is derived by mocking an optical system of the mask inspection device. Therefore, the mask pattern of the mask inspection simulation result 53 has a shape which is the same as that of the mask pattern which is actually observed by the inspection device. Since the inspection simulation result verification device 60 detects a mask inspection hotspot from the mask inspection simulation result 53 based on whether or not the mask inspection simulation result 53 satisfies the specs, it is possible to inspect presence/absence of the mask inspection hotspot with high accuracy. A position of an acceptable region 63 on the mask inspection simulation result 53 corresponds to the position of the defective region 61 on the mask data.

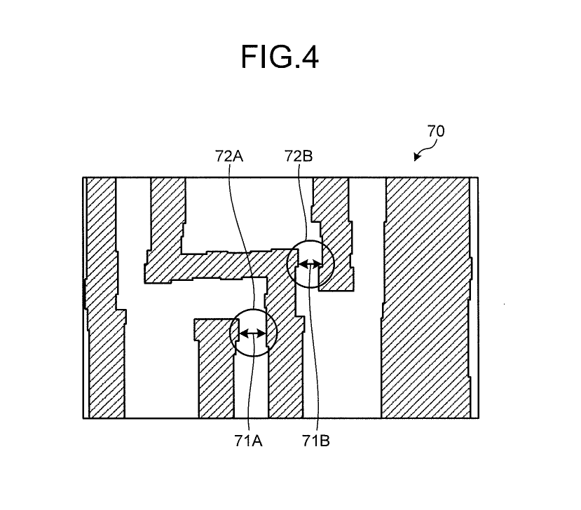

FIG. 4 is a diagram illustrating examples of positions of mask data for which hotspot determination is performed. In mask data 70, whether or not dimensions 71A, 71B in pattern regions 72A, 72B are within an allowable range is determined. For example, when the rule-based mask data check is performed on the mask data 70, the pattern regions 72A, 72B are sometimes determined to be the hotspots. Meanwhile, when mask lithography hotspot inspection is performed on a mask lithography simulation result in the case where the lithography simulation is performed on the mask data 70, the pattern regions 72A, 72B are sometimes determined to be normal points. In the case where the pattern regions 72A, 72B are determined to be the hotspots, correction which is not optimized for the mask data of the pattern regions 72A, 72B (unnecessary OPC) is performed. As a result, a problem of a reduction of a common margin of lithography occurs.

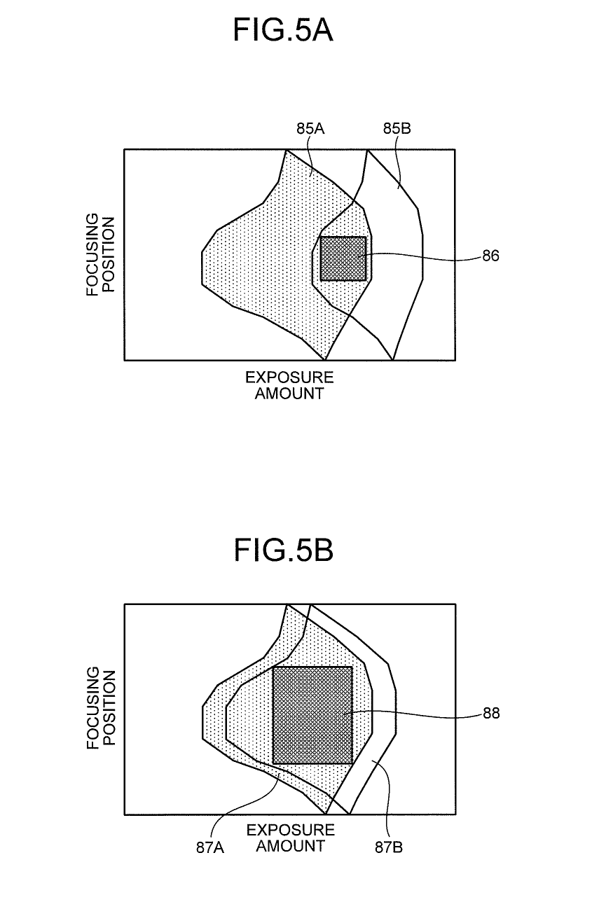

FIGS. 5A and 5B are diagrams each illustrating a lithography margin. Illustrated in FIG. 5A is a lithography margin in the case where the unnecessary OPC pattern correction is performed on the pattern region 72B. Illustrated in FIG. 5B is a lithography margin in the case where any pattern correction is not performed on the pattern regions 72A, 72B, respectively.

In each of FIGS. 5A and 5B, the horizontal axis indicates an exposure amount, and the vertical axis indicates a focusing position. Lithography margin regions 85A, 85B illustrated in FIG. 5A are lithography margins in the pattern regions 72A, 72B, and regions 87A, 87B illustrated in FIG. 5B are lithography margins in the pattern regions 72A, 72B. Each of the lithography margin regions 85A, 85B, 87A, and 87B is an allowable range relating to the lithography defined by an allowable range of the exposure amount and an allowable range of the focusing position.

In the case where the unnecessary OPC pattern correction is performed on the pattern region 72B, the lithography margin region 85B is shifted in a direction away from the lithography margin region 85A to narrow a common region 86 of the lithography margin regions 85A, 85B. This means a reduction of the lithography margin when subjecting the pattern regions 72A, 72B to exposure.

In contrast, in the case where the unnecessary OPC pattern correction is not performed on the pattern region 72B, the lithography margin region 87B is close to the lithography margin region 87A. Therefore, a common region 88 of the lithography margin regions 87A, 87B remains to be wide. This means that the lithography margin when subjecting the pattern regions 72A, 72B to exposure remains to be large. Thus, since it is possible to prevent the unnecessary OPC pattern correction in the present embodiments, it is possible to optimize the lithography conditions (exposure amount, focusing position, and the like).

The mask data to be inspected in the present embodiments may be any one of mask data of an optical mask, mask data of an EUV mask, and a mask (template) which is used in imprint lithography such as NIL (Nano Imprint Lithography).

Also, though the mask inspection system 1 changes the design layout data, the OPC conditions C1, the lithography conditions C2, the inspection conditions C3, and the like in the case where there is the mask lithography hotspot or the mask inspection hotspot in the present embodiments, at least one of mask production process conditions other than the mask data, wafer production process conditions, the OPC conditions C1, and the lithography conditions C2 may be changed.

For example, at least one of the semiconductor integrated circuit pattern, the original data, and processing conditions for the original production process may be changed so as to satisfy the predetermined value in the case where there is the mask lithography hotspot.

Also example, at least one of design layout data of the semiconductor integrated circuit pattern, the original data, the processing conditions of the original production process, and conditions for inspecting the original may be changed so that the original measurement pattern information is within the allowable range in the case where there is the mask inspection hotspot.

As described above, the mask inspection system 1 determines the mask data by performing the mask lithography simulation and the mask inspection simulation in view of the mask production limit and the mask inspection limit. Further, since the mask inspection system 1 changes various conditions and the like until there are not any mask lithography hotspot and mask inspection hotspot, the lithography conditions, OPC, or SMO (Source Mask Optimization) is optimized.

Also, since the mask inspection system 1 eliminates the unnecessary OPC correction by improving noise check accuracy by the mask lithography simulation and the mask inspection simulation, it is possible to prevent the reduction of the lithography margin.

The mask data inspection by the mask inspection system 1 is performed for each of layers of a wafer process, for example. A mask is produced by applying the OPC conditions C1, the lithography conditions C2, the inspection conditions C3, and the mask production process conditions which are changed as required to the mask data which are corrected as required. The pattern formation is performed on the wafer under the wafer production process conditions which are changed as required.

More specifically, after film formation processing or the like is performed on a wafer, a resist is coated on the wafer. Exposure on the resist-coated wafer is performed by using a mask. After that, the wafer is developed to form a resist pattern on the wafer. A lower layer of the wafer is etched by using the resist pattern as a mask, and, thus, an actual pattern corresponding to the resist pattern is formed on the wafer. In the case of producing a semiconductor device, the above-described mask data determination, mask data correction, change of various conditions for producing the mask and the semiconductor device, mask production, exposure processing on the wafer using the mask, wafer development processing, wafer etching processing, and the like are repeated for the layers.

Hereinafter, hardware configurations of the mask lithography simulation device 10 and the mask inspection simulation device 20 will be described. Since the mask lithography simulation device 10 and the mask inspection simulation device 20 has an identical hardware configuration, the hardware configuration of the mask lithography simulation device 10 will be described.

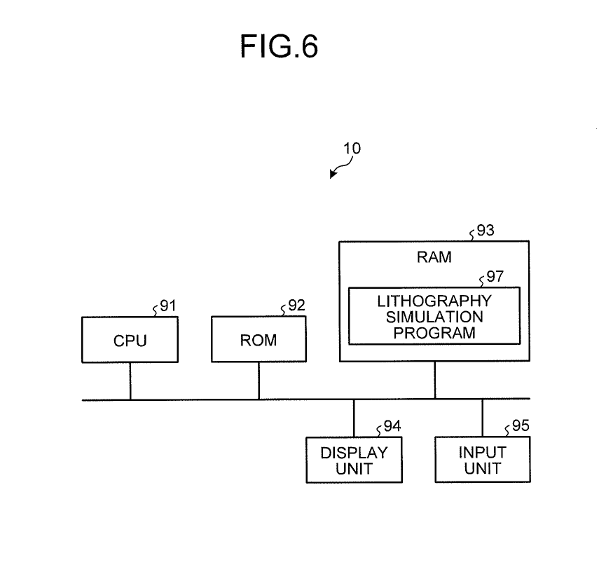

FIG. 6 is a diagram illustrating the hardware configuration of the mask lithography simulation device. The mask simulation device 10 has a CPU (Central Processing Unit) 91, a ROM (Read Only Memory) 92, a RAM (Random Access Memory) 93, a display unit 94, and an input unit 95. In the mask lithography simulation device 10, the CPU 91, ROM 92, RAM 93, display unit 94, and input unit 95 are connected to one another via a bus line.

The CPU 91 performs the mask lithography simulation by using a lithography simulation program 97 which is a computer program. The display unit 94 is a display device such as a liquid crystal monitor and displays mask data, lithography conditions, a mask lithography simulation result, or the like based on a command sent from the CPU 91. The input unit 95 is formed of a mouse and a keyboard for inputting command information (parameters required for lithography simulation or the like) which is externally inputted by the user. The command information inputted to the input unit 95 is sent to the CPU 91.

The lithography simulation program 97 is stored in the ROM 92 and loaded onto the RAM 93 via the bus line. Illustrated in FIG. 6 is a state in which the lithography simulation program 97 is loaded onto the RAM 93.

The CPU 91 executes the lithography simulation program 97 loaded in the RAM 93. More specifically, in the mask lithography simulation device 10, the CPU 91 reads out the lithography simulation program 97 from the ROM 92 in accordance with command input from the input unit 95 by the user and expands the lithography simulation program 97 to a program storage region in the RAM 93, thereby executing various processing. The CPU 91 causes various data generated in the various processing to be temporarily stored in a data storage region formed in the RAM 93.

The lithography simulation program 97 which is executed by the mask lithography simulation device 10 has a module structure including the lithography simulation unit 14, and the modules are loaded onto a main storage device to be generated on the main storage device.

According to the present embodiments, since the mask lithography hotspot is inspected based on the mask lithography simulation result, it is possible to extract the mask lithography hotspot with high accuracy and easily. Also, since the mask inspection hotspot is detected based on the mask inspection simulation result, it is possible to detect the mask lithography hotspot with high accuracy and easily. Therefore, it is possible to perform the mask inspection on the mask data with high accuracy and easily, thereby making it possible to easily provide the high accuracy mask data.

Also, since it is possible to correctly determine the mask lithography hotspot and the mask inspection hotspot, it is possible to prevent unnecessary mask data correction and unnecessary condition change. Therefore, it is possible to prevent the reduction of lithography margin, thereby making it possible to reduce a mask production load.

Also, since the mask inspection simulation is performed by using the mask lithography simulation result, it is possible to extract the mask inspection hotspot with high accuracy and easily. Therefore, it is possible to reduce a mask inspection load.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mask inspection method comprising:
creating original data corresponding to a semiconductor integrated circuit pattern to be formed on a substrate;
performing original production simulation which mocks an original production process on the original data to derive, as original production pattern information, information relating to an original pattern shape in the case of forming an original pattern corresponding to the original data on an original;
determining whether or not the original production pattern information satisfies a predetermined value decided based on the original production process;
performing original inspection simulation which mocks an optical system of an original inspection device to be used for inspection of the original to derive, as original measurement pattern information, information relating to an original pattern shape to be detected when the original inspection device inspects the original; and
determining whether or not a result of the inspection of the original is within an allowable range by using the original measurement pattern information.

2. The mask inspection method according to claim 1, wherein the original inspection simulation is performed by using the original data or the simulation result of the original production simulation.

3. The mask inspection method according to claim 1, wherein the determination of whether or not the original inspection result is within the allowable range is performed by determining whether or not the original measurement pattern information satisfies the predetermined value decided based on the original production process.

4. The mask inspection method according to claim 1, wherein the determination of whether or not the original inspection result is within the allowable range is performed by setting the original measurement pattern information as a reference image for inspecting the original, comparing the set reference image and a measurement result obtained by actual measurement of the original pattern, and determining whether or not the original inspection result is within the allowable range based on a result of the comparison result.

5. The mask inspection method according to claim 1, wherein the original data are mask data of an optical mask, mask data of an EUV mask, or mask data of a mask which is used in imprint lithography.

6. A mask production method comprising:
creating original data corresponding to a semiconductor integrated circuit pattern to be formed on a substrate;
performing original production simulation which mocks an original production process on the original data to derive, as original production pattern information, information relating to an original pattern shape in the case of forming an original pattern corresponding to the original data on an original;
determining whether or not the original production pattern information satisfies a predetermined value decided based on the original production process;
performing original inspection simulation which mocks an optical system of an original inspection device to be used for inspection of the original to derive, as original measurement pattern information, information relating to an original pattern shape to be detected when the original inspection device inspects the original;
determining whether or not a result of the inspection of the original is within an allowable range by using the original measurement pattern information;
forming the original pattern corresponding to the original data on the original;
changing at least one of the semiconductor integrated circuit pattern, the original data, and processing conditions for the original production process so as to satisfy the predetermined value in the case where the original production pattern information does not satisfy the predetermined value; and
changing at least one of design layout data of the semiconductor integrated circuit pattern, the original data, the processing conditions of the original production process, and conditions for inspecting the original so that the original measurement pattern information is within the allowable range in the case where the original measurement pattern information is outside the allowable range.

7. The mask production method according to claim 6, wherein the processing conditions of the original production process include at least one of conditions relating to original lithography and conditions relating to original processing process when forming the original pattern corresponding to the original data on the original.

8. The mask production method according to claim 6, wherein the original inspection simulation is performed by using the original data or a simulation result of the original production simulation.

9. The mask production method according to claim 6, wherein the determination of whether or not the original inspection result is within the allowable range is performed by determining whether or not the original measurement pattern information satisfies the predetermined value decided based on the original production process.

10. The mask production method according to claim 6, wherein the determination of whether or not the original inspection result is within the allowable range is performed by setting the original measurement pattern information as a reference image for inspecting the original, comparing the set reference image and a measurement result obtained by actual measurement of the original pattern, and determining whether or not the original inspection result is within the allowable range based on a result of the comparison result.

11. The mask production method according to claim 6, wherein the original data are mask data of an optical mask, mask data of an EUV mask, or mask data of a mask which is used in imprint lithography.

12. A semiconductor device production method comprising:
creating original data corresponding to a semiconductor integrated circuit pattern to be formed on a substrate;
performing original production simulation which mocks an original production process on the original data to derive, as original production pattern information, information relating to an original pattern shape in the case of forming an original pattern corresponding to the original data on an original;
determining whether or not the original production pattern information satisfies a predetermined value decided based on the original production process;
performing original inspection simulation which mocks an optical system of an original inspection device to be used for inspection of the original to derive, as original measurement pattern information, information relating to original pattern shape to be detected when the original inspection device inspects the original;
determining whether or not a result of the inspection of the original is within an allowable range by using the original measurement pattern information;
forming the original pattern corresponding to the original data on the original;
forming the semiconductor integrated circuit pattern by transferring the original pattern on the substrate;
changing at least one of the semiconductor integrated circuit pattern, the original data, processing conditions for the original production process, and production process conditions of the semiconductor integrated circuit pattern to be formed on the substrate so as to satisfy the predetermined value in the case where the original production pattern information does not satisfy the predetermined value; and
changing at least one of design layout data of the semiconductor integrated circuit pattern, the original data, the processing conditions of the original production process, conditions for inspecting the original, and production process conditions of the semiconductor integrated circuit pattern to be formed on the substrate so that the original measurement pattern information is within the allowable range in the case where the original measurement pattern information is outside the allowable range.

13. The semiconductor device production method according to claim 12, wherein the processing conditions of the original production process include at least one of conditions relating to original lithography and conditions relating to original processing process when forming the original pattern corresponding to the original data on the original.

14. The semiconductor device production method according to claim 12, wherein the original inspection simulation is performed by using the original data or a simulation result of the original production simulation.

15. The semiconductor device production method according to claim 12, wherein the determination of whether or not the original inspection result is within the allowable range is performed by determining whether or not the original measurement pattern information satisfies the predetermined value decided based on the original production process.

16. The semiconductor device production method according to claim 12, wherein the determination of whether or not the original inspection result is within the allowable range is performed by setting the original measurement pattern information as a reference image for inspecting the original, comparing the set reference image and a measurement result obtained by actual measurement of the original pattern, and determining whether or not the original inspection result is within the allowable range based on a result of the comparison result.

17. The semiconductor device production method according to claim 12, wherein the original data are mask data of an optical mask, mask data of an EUV mask, or mask data of a mask which is used in imprint lithography.

18. A mask inspection device comprising:
an input unit which inputs original data corresponding to a semiconductor integrated circuit pattern to be formed on a substrate;
a simulation unit which performs original production simulation which mocks an original production process on the original data to derive, as original production pattern information, information relating to an original pattern shape in the case of forming an original pattern corresponding to the original data on an original; and
a verification unit which determines whether or not the original production pattern information satisfies a predetermined value decided based on the original production process.

19. A mask inspection device comprising:
an input unit which inputs an original pattern shape of an original used for forming a semiconductor integrated circuit pattern on a substrate;
a simulation unit which performs original inspection simulation which mocks an optical system of an original inspection device to be used for inspection of the original to derive, as original measurement pattern information, information relating to an original pattern shape to be detected when the original inspection device inspects the original; and
a determination unit which determines whether or not a result of the inspection of the original is within an allowable range by using the original measurement pattern information.
